(19) United States
(12) Patent Application Publication
(10) Pub. No.: US 2022/0198510 A1
(43) Pub. Date: Jun. 23, 2022

(54) TIMING ADVERTISING TO USER RECEPTIVITY

(71) Applicants: Maarten Bos, Marina Del Rey, CA (US); Farhan Asif Chowdhury, Albuquerque, NM (US); Yozen Liu, Aliso Viejo, CA (US); Leonardo Ribas Machado das Neves, Marina del Rey, CA (US); Koustuv Saha, Atlanta, GA (US); Neil Shah, Los Angeles, CA (US); Nicholas Vincent, Evanston, IL (US)

(72) Inventors: Maarten Bos, Marina Del Rey, CA (US); Farhan Asif Chowdhury, Albuquerque, NM (US); Yozen Liu, Aliso Viejo, CA (US); Leonardo Ribas Machado das Neves, Marina del Rey, CA (US); Koustuv Saha, Atlanta, GA (US); Neil Shah, Los Angeles, CA (US); Nicholas Vincent, Evanston, IL (US)

(21) Appl. No.: 17/127,335

(22) Filed: Dec. 18, 2020

(51) Int. Cl. G06Q 30/02; H04L 29/08; G06F 16/22

(52) U.S. Cl. CPC G06Q 30/0246; H04L 67/306; G06Q 30/0277; H04L 67/20; G06Q 30/0201; G06Q 30/0269; G06F 16/2228; G06Q 30/0272

(57) ABSTRACT

A processor collecting advertisement (ad) events of a user using a mobile device, such as a mobile phone or eyewear, parsing the ad events from the mobile device, and generating an ad receptivity profile on the granularity of a user identification (ID) and an hour of day. In one example, the processor computes the percentage of ad time watched by the individual user, such as on an hourly basis, and by monitoring a click-through rate (CTR) of the respective user as a measure for user ad receptivity. The processor adjusts an ad allocation/ad load on a per user basis according the user level ad receptivity profile, resulting in dynamically providing ads on the mobile device display when a user is active and receptive viewing the ads.

### TECHNICAL FIELD

The present disclosure generally relates to performance events of a user of an application operable on various client devices.

### BACKGROUND

Performance events of a user of an application, conventionally referred to as an app, vary from user to user. The user engagement time of the app can vary based on the user's interest in the content presented on the display, and the time available of the user.

### BRIEF DESCRIPTION OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 is a block diagram illustrating a system configured to automatically generate an ad receptivity profile;

FIG. 2 is a block diagram illustrating an ad receptivity app operable by a processor on a server system;

FIG. 3 illustrates user receptivity profiles;

FIG. 4 illustrates ad allocation/load for a particular user as a function of that user's receptivity profile;

FIG. 5 is a high-level functional block diagram of an example client device comprising a mobile device that communicates via network with server system; and

FIG. 6 is a diagrammatic representation of a machine in the form of a computer system within which a set of instructions may be executed for causing the machine to perform any one or more of the methodologies discussed herein, in accordance with some examples.

### DETAILED DESCRIPTION

This disclosure includes a processor collecting advertisement (ad) events of a user using a mobile device, such as a mobile phone or eyewear, parsing the ad events from the mobile device, and generating an ad receptivity profile on the granularity of a user identification (ID) and an hour of day. In one example, the processor computes both the percentage of ad time watched by the individual user, such as on an hourly basis, and ad engagement such as by monitoring a click-through rate (CTR) of the respective user as a measure for user ad receptivity. The processor adjusts ad allocation/ad load on a per user basis according to a user-level ad receptivity profile, resulting in dynamically providing ads on the mobile device display when a user is active and receptive to viewing the ads. This allocation approach's efficacy helps platforms to accomplish monetary goals with fewer ads, and therefore, can lead to allocating fewer ads, a solution that is appreciated by users. This disclosure also enables platforms to price their ad space as a function of a user's known receptivity, which can increase the platform's profitability and the advertiser's viewing rate.

This disclosure allows platforms, such as social media platforms, to allocate ads in an effective, fair, and less intrusive way. Showing ads delivers revenue for online content distributors, but ad exposure can compromise user experience and cause user fatigue and frustration. Correctly balancing ads with other content is imperative. Currently, ad allocation relies primarily on demographics and inferred user interests, which are treated as static features and can be privacy-intrusive. Three categories of user ad dissatisfaction are intrusiveness, annoyance, and disruptiveness of ads. Users often use ad blockers and other tools that prevent ads on online platforms. These approaches raise nuanced questions surrounding the sustainability of platforms surviving on ad-driven business models. Consequently, to protect the user base and minimize ad-based interruptions, some platforms are moving away from ad-based models to some form of subscription-based models. However, such models have their own caveats, such as inequity of information access on the internet, and online services could become a function of an individual's ability to pay.

This disclosure provides a middle-ground, by optimizing ad timings and allocations when users are less likely to feel interrupted, such that platforms can consistently provide equitable content access and experience to users, and better sustain the ad revenue ecosystem, with less user dissatisfaction.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

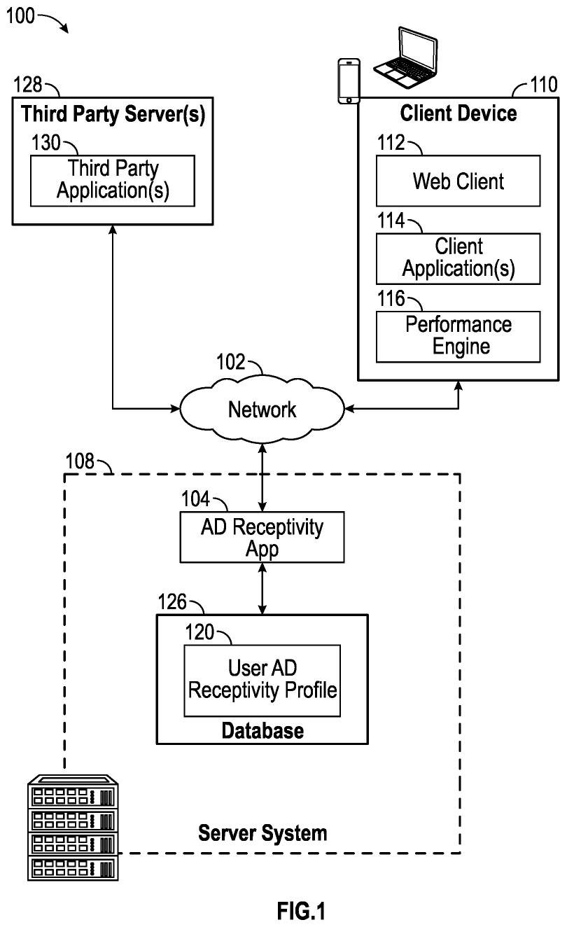

FIG. 1 is a block diagram illustrating a system 100, according to some examples, configured to automatically generate a user-specific ad receptivity profile by hour of day. In one example, the processor computes the percentage of ad time watched by the individual user, and also monitors a click-through rate (CTR) as a measure for ad receptivity. The processor adjusts an ad allocation/ad load on a per user basis according to the hourly user level ad receptivity profile, resulting in dynamically providing ads when a user is active and receptive to viewing the ads. The ad allocation/ad load is the number of ads presented to the user for a period of time. The system 100 includes one or more client devices 110. The client device 110 includes, but is not limited to, a mobile phone, eyewear, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the system 100. In some examples, the client device 110 includes a display module (not shown) to display information (e.g., in the form of user interfaces), and which include ads. In further examples, the client device 110 includes one or more of touch screens, accelerometers, gyroscopes, cameras, microphones, global positioning system (GPS) devices, and so forth. The client device 110 may be a device of a user that is used to access and utilize an online social platform.

For example, client device 110 is a device of a given user who uses an application 114 on an online social platform. Client device 110 accesses a web site of an online social platform hosted by a server system 108. The user inputs login credentials associated with the user. Server system receives the request and provides access to the online social platform.

A user of the client device 110 launches and engages an application 114 hosted by the server system 108. The client device 110 has a performance engine 116 including client code performing the observation of performance events on the client device 110, including monitoring the percentage of ad time watched by the individual user, and the user engagement of the ads such as by monitoring a click-through rate (CTR) as a measure for ad receptivity. The performance engine 116 downloads the performance events to the server system 108 without significantly affecting operation of the application 114.

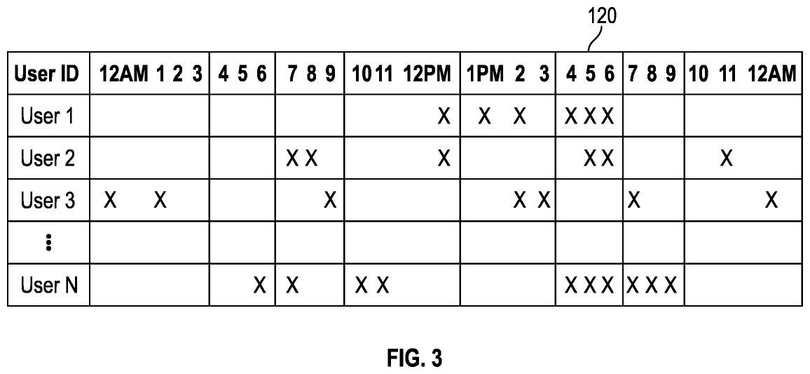

An ad receptivity application 104 in the server system 108 receives and processes the received performance events to compute the percentage of ad time watched by the individual user, and groups user IDs as a function of ad receptivity and generates a data structure comprising an ad receptivity profile 120 (FIG. 3). The ad receptivity application 104 adjusts an ad allocation/ad load 404 on client device 110 on a per user basis according to the hourly user level ad load, resulting in dynamically providing and displaying ads on the client device 110 display when a user is calculated to be active and receptive to viewing the ads (FIG. 3).

One or more users may be a person, a machine, or other means of interacting with the client device 110. In examples, the user may not be part of the system 100 but may interact with the system 100 via the client device 110 or other means. For instance, the user may provide input (e.g., touch screen input or alphanumeric input) to the client device 110 and the input may be communicated to other entities in the system 100 (e.g., third-party servers 130, server system 108, etc.) via the network 102. In this instance, the other entities in the system 100, in response to receiving the input from the user, may communicate information to the client device 110 via the network 102 to be presented to the user. In this way, the user interacts with the various entities in the system 100 using the client device 110.

The system 100 further includes a network 102. One or more portions of network 102 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a 4G LTE network, a 5G network, another type of network, or a combination of two or more such networks.

The client device 110 may access the various data and applications provided by other entities in the system 100 via web client 112 (e.g., a browser) or one or more client applications 114. The client device 110 may include one or more client application(s) 114 (also referred to as “apps”) such as, but not limited to, a web browser, messaging application, electronic mail (email) application, an e-commerce site application, a mapping or location application, an online home buying and selling application, a real estate application, and the like.

In some examples, one or more client application(s) 114 are included in a given one of the client device 110, and configured to locally provide the user interface and at least some of the functionalities, with the client application(s) 114 configured to communicate with other entities in the system 100 (e.g., third-party server(s) 128, server system 108, etc.), on an as-needed basis, for data processing capabilities not locally available (e.g., to access location information, to authenticate a user, etc.). Conversely, one or more client application(s) 114 may not be included in the client device 110, and then the client device 110 may use its web browser to access the one or more applications hosted on other entities in the system 100 (e.g., third-party server(s) 128, server system 108, etc.).

Server system 108 provides server-side functionality via the network 102 (e.g., the Internet or wide area network (WAN)) to: one or more third party server(s) 128, and one or more client devices 110. The server system 108 includes the one or more database(s) 126 that may be storage devices that store the user ad receptivity profile 120 of the plurality of users of client devices 110. The database may comprise one or more tables (FIG. 3) that include the user id of users, and the ad time watched by the respective user for a period of time, such as the percentage of ad time watched by the respective user each hour of the day.

The one or more database(s) 126 may further store information related to third party server(s) 128, third-party application(s) 130, client device 110, client application(s) 114, users, and so forth. In one example, the one or more database(s) 126 may be cloud-based storage.

The server system 108 may be a cloud computing environment, according to some examples. The server system 108, and any servers associated with the server system 108, may be associated with a cloud-based application, in one example.

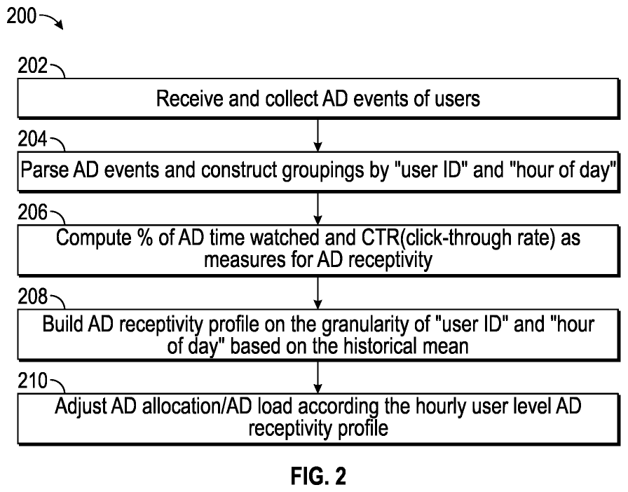

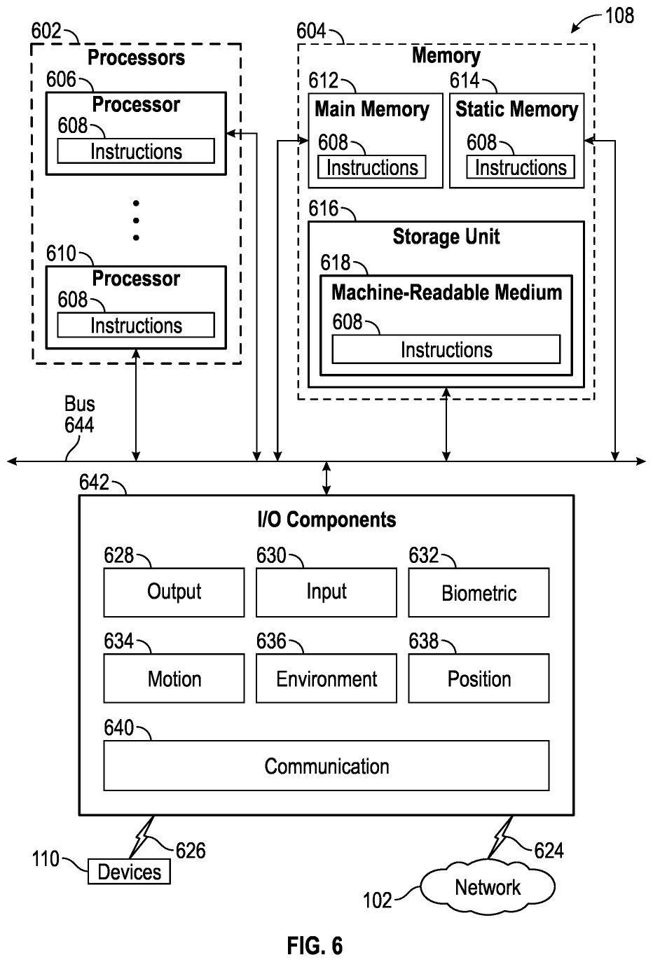

FIG. 2 is a block diagram 200 illustrating the ad receptivity app 104 operable by a processor 906 (FIG. 6) on the server system 108.

The users of the client devices 110 launch and engage respective application 114 hosted by the server system 108. The performance engine 116 of each client device 110 includes client code performing the observation of performance events on the respective client device 110, including monitoring the specific user percentage of ad time watched by the individual user, and monitoring the CTR of the user as a measure for ad receptivity. The CTR of the user engaging the application 114 and watching ads increases when the user is actively engaging the application and ads displayed on the display. The code is configured such that the CTR is directly associated with the number of ads clicked by the user. For example, if the user engages 10 ads during a period, such as an hour, by clicking on all 10 ads, the user may be determined to be watching ads 100% of the period. If the user clicks on 3 ads during the period, the user may be determined to be watching the ads 30% of the time. In addition, the CTR of the user engaging the application 114 itself, even if the user does not click on the ad, is monitored as the performance engine 116 determines when the user is viewing the application 114 and receptive to looking at an ad, even if it is not clicked. Each performance engine 116 of the client devices 100 download the performance events of the respective user along with the user ID of the respective user to the server system 108 without significantly affecting operation of the application 114.

At block 202, processor 906 receives and collects ad events of users parsing the ad events from the performance engine 116 of respective client devices 110. The user ID of each user is associated with the respective ad events. In an example, the CTR of the user is associated with the user ID and is downloaded to processor 906.

At block 204, processor 906 parses the ad events on a per user ID basis. The processor 906 constructs groupings of the user ID and hour of day. The groupings are stored in memory 912 as a database structure.

At block 206, processor 906 computes the ad time watched by the respective user as measures for user ad receptivity. In an example, the CTR associated with each user ID is computed where the CTR is indicative of and corresponds to the user ad receptivity.

At block 208, the processor 906 generates the ad receptivity profile 120 shown in FIG. 3 on the granularity of user ID and hour of day based on the historical mean. As shown, the different users have different receptivity through a day, based on their preferences, work schedule, personal schedule, personal attributes, and so forth.

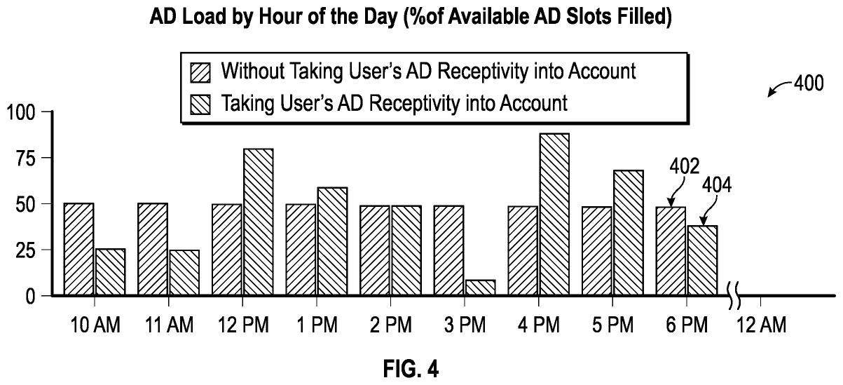

At block 210, the processor 906 adjusts the allocation/ad load associated with the users of the client device 110 according to the hourly user level ad receptivity profile 120 of the user using client device 110. The allocation/ad load is associated with the user ID of the users of the client devices 110. An example of the allocation/ad load for a given user ID is shown generally at 400 in FIG. 4. In this example, in a nominal system the respective allocation/ad load 402 established by processor 906 for the user ID of User 1 is 50% each hour of the day. According to this disclosure the adjusted allocation/ad load 404 for User 1 is custom and dynamically set each hour by the processor 906 as a function of the user ad receptivity profile. For example, at 12 pm the adjusted load profile 404 for User 1 is 80% when the respective user is determined to be receptive to ads based on the CTR at 12 pm, as shown in FIG. 3. Similarly, the adjusted load profile 404 for User 1 is 25% when the user is determined to not be receptive to ads based on the CTR at 10 am, as shown in FIG. 3.

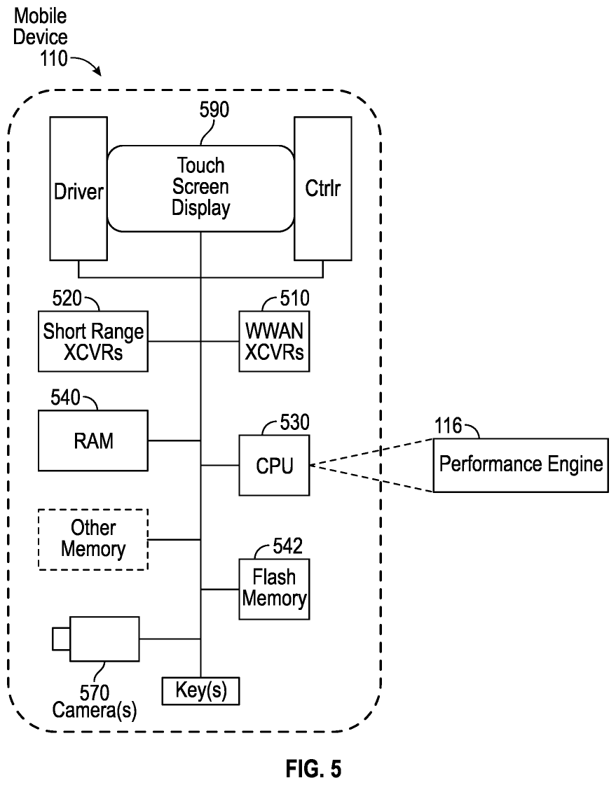

FIG. 5 is a high-level functional block diagram of an example client device 110 comprising a mobile device that communicates via network 102 with server system 108 of FIG. 1 Shown are elements of a touch screen type mobile device 110 having the performance engine 116, although other non-touch type mobile devices can be used under consideration here. Examples of touch screen type mobile devices that may be used include (but are not limited to) a smart phone, a personal digital assistant (PDA), a tablet computer, a laptop computer, or other portable device. However, the structure and operation of the touch screen type devices is provided by way of example, and the subject technology as described herein is not intended to be limited thereto. For purposes of this discussion, FIG. 5 therefore provides a block diagram illustration of the example mobile device 110 having a touch screen display for displaying content and receiving user input as (or as part of) the user interface. Mobile device 110 also includes a camera(s) 570, such as visible light camera(s).

The activities that are the focus of discussions here involve monitoring and reporting of performance metrics of application 114 running on the mobile phone 110. As shown in FIG. 5, the mobile device 110 includes at least one digital transceiver (XCVR) 510, shown as WWAN XCVRs, for digital wireless communications via a wide area wireless mobile communication network 102. The mobile device 110 also includes additional digital or analog transceivers, such as short range XCVRs 520 for short-range network communication, such as via NFC, VLC, DECT, ZigBee, Bluetooth™, or WiFi. For example, short range XCVRs 520 may take the form of any available two-way wireless local area network (WLAN) transceiver of a type that is compatible with one or more standard protocols of communication implemented in wireless local area networks, such as one of the Wi-Fi standards under IEEE 802.11 and 4G LTE.

To generate location coordinates for positioning of the mobile device 110, the mobile device 110 can include a global positioning system (GPS) receiver. Alternatively, or additionally the mobile device 110 can utilize either or both the short range XCVRs 520 and WWAN XCVRs 510 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 820.

The transceivers 510, 520 (network communication interface) conforms to one or more of the various digital wireless communication standards utilized by modern mobile networks. Examples of WWAN transceivers 510 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G” and 5G. For example, the transceivers 510, 520 provide two-way wireless communication of information including digitized audio signals, still image and video signals, web page information for display as well as web related inputs, and various types of mobile message communications to/from the mobile device 110 for user identification strategies.

Several of these types of communications through the transceivers 510, 520 and a network, as discussed previously, relate to protocols and procedures in support of communications with the server system 108 for performing performance metric monitoring and gating. Such communications, for example, may transport packet data via the short range XCVRs 520 over the wireless connections of network 102 to and from the server system 108 as shown in FIG. 1. Such communications, for example, may also transport data utilizing IP packet data transport via the WWAN XCVRs 510 over the network (e.g., Internet) 102 shown in FIG. 1. Both WWAN XCVRs 510 and short range XCVRs 520 connect through radio frequency (RF) send-and-receive amplifiers (not shown) to an associated antenna (not shown).

The mobile device 110 further includes a processor 530, shown as a CPU, sometimes referred to herein as the host controller. A processor is a circuit having elements structured and arranged to perform one or more processing functions, typically various data processing functions. Although discrete logic components could be used, the examples utilize components forming a programmable CPU. A processor for example includes one or more integrated circuit (IC) chips incorporating the electronic elements to perform the functions of the CPU. The processor 530, for example, may be based on any known or available processor architecture, such as a Reduced Instruction Set Computing (RISC) using an ARM architecture, as commonly used today in mobile devices and other portable electronic devices. Of course, other processor circuitry may be used to form the CPU 530 or processor hardware in smartphone, laptop computer, and tablet.

The processor 530 serves as a programmable host controller for the mobile device 110 by configuring the mobile device to perform various operations, for example, in accordance with instructions or programming executable by processor 530. For example, such operations may include various general operations of the mobile device, as well as operations related to performance metric monitoring, reporting to server system 108, and gating. Although a processor may be configured by use of hardwired logic, typical processors in mobile devices are general processing circuits configured by execution of programming.

The mobile device 110 includes a memory or storage device system, for storing data and programming. In the example, the memory system may include a flash memory 540 and a random access memory (RAM) 542. The RAM 542 serves as short term storage for instructions and data being handled by the processor 530, e.g. as a working data processing memory. The flash memory 540 typically provides longer term storage.

Hence, in the example of mobile device 110, the flash memory 540 is used to store programming or instructions for execution by the processor 530. Depending on the type of device, the mobile device 110 stores and runs a mobile operating system through which specific applications, including application 114. Applications, such as the performance metric monitoring, may be a native application, a hybrid application, or a web application (e.g., a dynamic web page executed by a web browser) that runs on mobile device 110 to uniquely identify the user. Examples of mobile operating systems include Google Android®, Apple iOS® (I-Phone or iPad devices), Windows Mobile®, Amazon Fire OS®, RIM BlackBerry® operating system, or the like.

As shown, flash memory 542 storage device stores a database of performance metrics determined by performance engine 116. The database of performance metrics is accumulated over time as different users run application 114. The flash memory 542 also stores gating information of the client device 110, including which features are enabled and unenabled based on the performance metrics.

FIG. 6 is a diagrammatic representation of the server system 108 within which instructions 908 (e.g., software, a program, an application, an applet, an app, or other executable code) for causing the server system 108 to perform any one or more of the methodologies discussed herein may be executed. For example, the instructions 908 may cause the server system 108 to execute any one or more of the methods described herein. In a networked deployment, the server system 108 may operate in the capacity of a server machine or a client machine in a server-client network environment, or as a peer machine in a peer-to-peer (or distributed) network environment. The server system 108 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the server system 108.

The server system 108 may include processors 902, memory 904, and I/O components 942, which may be configured to communicate with each other via a bus 944. In an example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that execute the instructions 908. The term “processor” is intended to include multi-core processors that may comprise two or more independent processors (sometimes referred to as “cores”) that may execute instructions contemporaneously. Although FIG. 6 shows multiple processors 902, the server system 108 may include a single processor with a single core, a single processor with multiple cores (e.g., a multi-core processor), multiple processors with a single core, multiple processors with multiples cores, or any combination thereof.

The memory 904 includes a main memory 912, a static memory 914, and a storage unit 916, both accessible to the processors 902 via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 (e.g., a non-transitory machine-readable storage medium) within the storage unit 916, within at least one of the processors 902 (e.g., within the processor's cache memory), or any suitable combination thereof, during execution thereof by the server system 108.

Furthermore, the machine-readable medium 918 is non-transitory (in other words, not having any transitory signals) in that it does not embody a propagating signal. However, labeling the machine-readable medium 918 “non-transitory” should not be construed to mean that the medium is incapable of movement; the medium should be considered as being transportable from one physical location to another. Additionally, since the machine-readable medium 918 is tangible, the medium may be a machine-readable device.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones may include a touch input device or other such input mechanisms, while a headless server machine will likely not include such a touch input device. It will be appreciated that the I/O components 942 may include many other components that are not shown in FIG. 6. In various examples, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 942 may include biometric components 932, motion components 934, environmental components 936, or position components 938, among a wide array of other components. For example, the biometric components 932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 include acceleration sensor components (e.g., accelerometer), gravitation sensor components, rotation sensor components (e.g., gyroscope), and so forth. The environmental components 936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 942 further include communication components 940 operable to couple the server system 108 to network 102 and client devices 110 via a coupling 924 and a coupling 926, respectively. For example, the communication components 940 may include a network interface component or another suitable device to interface with the network 102. In further examples, the communication components 940 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 922 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geolocation, location via Wi-Fi® signal triangulation, location via detecting an NFC beacon signal that may indicate a particular location, and so forth.

The various memories (e.g., memory 904, main memory 912, static memory 914, memory of the processors 902), storage unit 916 may store one or more sets of instructions and data structures (e.g., software) embodying or used by any one or more of the methodologies or functions described herein. These instructions (e.g., the instructions 908), when executed by processors 902, cause various operations to implement the disclosed examples.

The instructions 908 may be transmitted or received over the network 102, using a transmission medium, via a network interface device (e.g., a network interface component included in the communication components 940) and using any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922

The terms and expressions used herein are understood to have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A method comprising:
receiving, by a processor, performance events from a plurality of client devices running an application, wherein the performance events of each of the plurality of client devices are a function of a user parsing advertisement (ad) events that are displayed on the respective client device;
aggregating, by the processor, the received performance events and creating a data structure comprising a user identification (ID) associated with the users and the performance events associated with the respective user;
creating, by the processor, a user ad receptivity profile for each of the user IDs that is indicative of a respective user's receptivity to receiving ads and a time of day; and
adjusting, by the processor, an ad load associated with the user IDs of the users of client devices as a function of the user ad receptivity profile.

2. The method of claim 1 wherein the user ad receptivity profile is unique to each said user ID.

3. The method of claim 1 further comprising computing, by the processor, ad time watched by the respective user as a measure of user ad receptivity.

4. The method of claim 1 wherein the performance events are associated with a click-through rate (CTR) of the user when the ad events are displayed on the respective client device.

5. The method of claim 1 further comprising constructing, by the processor, groupings of the user IDs and an hour of a day, and then storing the groupings in memory.

6. The method of claim 5 further comprising generating, by the processor, the ad receptivity profile based on the user ID and hour of day based on a historical mean.

7. The method of claim 1 further comprising receiving, by the processor, the plurality of performance events from a performance engine running on the plurality of client devices that monitors the user parsing ad events.

8. A system comprising:
a memory configured to store computer readable instructions; and
a processor configured by the instructions to perform operations comprising:
receiving performance events from a plurality of client devices running an application, wherein the performance events of each of the plurality of client devices are a function of a user parsing advertisement (ad) events that are displayed on the respective client device;
aggregating the received performance events and creating a data structure comprising a user identification (ID) associated with the users and the performance events associated with the respective user;
creating a user ad receptivity profile for each of the user IDs that is indicative of a respective user receptivity to receiving ads and a time of day; and
adjusting an ad load associated with the user IDs of the users of client devices as a function of the user ad receptivity profile.

9. The system of claim 8 wherein the user ad receptivity profile is unique to each said user ID.

10. The system of claim 8 wherein the processor is configured to compute ad time watched by the respective user as a measure of user ad receptivity.

11. The system of claim 8 wherein the performance events are associated with a click-through rate (CTR) of the user when the ad events are displayed on the respective client device.

12. The system of claim 8 wherein the processor is configured to group the user IDs and an hour of a day, and then storing the groupings.

13. The system of claim 12 wherein the processor is configured to generate the ad receptivity profile based on the user ID and hour of day based on a historical mean.

14. The system of claim 8 wherein the processor is configured to receive the plurality of performance events from a performance engine running on the plurality of client devices that monitors the user parsing ad events.

15. A non-transitory processor-readable storage medium storing processor-executable instructions that, when executed by a processor of a machine, cause the machine to perform operations comprising:
receiving performance events from a plurality of client devices running an application, wherein the performance events of each of the plurality of client devices are a function of a user parsing advertisement (ad) events that are displayed on the respective client device;
aggregating the received performance events and creating a data structure comprising a user identification (ID) associated with the users and the performance events associated with the respective user;
creating a user ad receptivity profile for each of the user IDs that is indicative of a respective user receptivity to receiving ads and a time of day; and
adjusting an ad load associated with the user IDs of the users of client devices as a function of the user ad receptivity profile.

16. The non-transitory processor-readable storage medium of claim 15, wherein the user ad receptivity profile is unique to each said user ID.

17. The non-transitory processor-readable storage medium of claim 15, further including instructions to compute ad time watched by the respective user as a measure of user ad receptivity.

18. The non-transitory processor-readable storage medium of claim 15, wherein the performance events are associated with a click-through rate (CTR) of the user when the ad events are displayed on the respective client device.

19. The non-transitory processor-readable storage medium of claim 15, further including instructions to construct groupings of the user IDs and an hour of a day, and then storing the groupings in a memory.

20. The non-transitory processor-readable storage medium of claim 19, further including instructions to generate the ad receptivity profile based on the user ID and hour of day based on a historical mean.
